(19) United States
(12) Patent Application Publication
(10) Pub. No.: US 2007/0291083 A1
(43) Pub. Date: Dec. 20, 2007

(54) INK JET HEAD UNIT, INK JET RECORDING APPARATUS, AND METHOD OF MANUFACTURING INK JET HEAD

(75) Inventors: Akira GYOUTOKU, Fukuoka (JP); Kenji OSHIMA, Fukuoka (JP); Hisahiro TANAKA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/761,533

(22) Filed: Jun. 12, 2007

(30) Foreign Application Priority Data
Jun. 19, 2006 (JP) 2006-168329
Jun. 19, 2006 (JP) 2006-168331

(51) Int. Cl. B41J 2/045

(52) U.S. Cl. 347/70

(57) ABSTRACT

There are provided a pressure chamber disposed on an ink jet head board and serving to discharge an ink with a pressure change, a piezoelectric vibrator disposed in the pressure chamber and serving to apply a pressure to the pressure chamber, a sealing cap for sealing a space including at least the piezoelectric vibrator, and plural kinds of drying agents disposed in a sealed space formed by the sealing cap and having moisture absorbing characteristics which are different from each other.

### BACKGROUND OF THE INVENTION

1. Field of the invention

The present invention relates to an ink jet head unit, an ink jet recording apparatus, and a method of manufacturing the ink jet head unit, and more particularly to an ink jet head unit of such a type as to deform a pressure chamber by a piezoelectric vibrator, thereby discharging an ink, an ink jet recording apparatus including the ink jet head unit as printing means, and a method of manufacturing the ink jet head unit.

2. Description of the related art

An ink jet recording apparatus serves to discharge an ink of several tens picoliters through a large number of nozzle holes having a diameter of several tens microns toward a recording medium such as a paper, thereby carrying out a printing operation. An ink discharging portion in the ink jet head unit provided in the ink jet recording apparatus is formed by a nozzle plate having a large number of nozzle holes provided thereon, a pressure chamber communicating with each of the nozzle holes, a common fluid chamber for supplying an ink to the pressure chamber, and a piezoelectric element (a piezoelectric vibrator) constituted by lead zirconate titanate (Pb(Zr, Ti)O₃) (PZT) for generating a pressure in the pressure chamber, for example.

When a high voltage is applied to the piezoelectric vibrator in an exposing state to an atmosphere having a high humidity for a long time, however, an electrical insulating property of the piezoelectric element is deteriorated so that a dielectric breakdown of the piezoelectric vibrator is caused. Such a phenomenon has a great drawback for a reliability of the piezoelectric element.

The drawback is remarkable for a piezoelectric element to be a thin film which is easily influenced by foreign matters because of a small film thickness.

The influence is apt to be remarkably made in an environment having a high temperature and a high humidity. For this reason, a great influence is also made by a poor external environment during a transportation.

As a method of suppressing an influence of moisture as greatly as possible to maintain a high reliability, therefore, there have been proposed a method of filling a dry fluid in a space formed by a passage substrate provided with a piezoelectric vibrator and an inner part of a sealing cap (for example, see JP-A-10-305578 Publication), a method of filling a drying agent and heat generating means in a sealed space including a piezoelectric element (for example, see JP-A-11-300957 Publication), and a method of continuously supplying a dry gas to a piezoelectric element without sealing and maintaining an atmosphere of an environment in which a piezoelectric vibrator is operated to be a certain dew point or more, thereby eliminating the influence of moisture (for example, see JP-A-2004-322605 Publication), for instance.

In the conventional art, however, it is hard to say that a sufficient ink jet head for a long-term reliability can be provided. The reason is that there is a possibility that a piezoelectric vibrator having a small film thickness in a thin film state might be influenced by a very small amount of moisture to cause a dielectric breakdown of an element.

As a result obtained by a detailed investigation of the amount of the moisture and the dielectric breakdown of the piezoelectric vibrator, therefore, it has been found that an environment having a dew point of −40□ or less is to be held for a surrounding environment in which the piezoelectric vibrator is operated in order to completely suppress the generation of the dielectric breakdown of the piezoelectric vibrator. In the conventional art, however, it is impossible to hold the environment having a dew point of −40□ or less for a long period of time.

### SUMMARY OF THE INVENTION

A main aspect of the invention is to completely remove the influence of moisture to be given to a piezoelectric vibrator by only closing and sealing and a drying agent without using other methods such as heat generating means, and furthermore, to specify a material of the drying agent in order to maintain the environment for a long period of time.

It is an object of the invention to provide an ink jet head unit having a small size and a high reliability, an ink jet recording apparatus, and a method of manufacturing the ink jet head unit.

An ink jet head unit according to the invention comprises a pressure chamber for discharging an ink with a pressure change, a piezoelectric vibrator provided in the pressure chamber and serving to apply a pressure to the pressure chamber, a sealing member for sealing a space including at least the piezoelectric vibrator, and plural kinds of drying agents disposed in a sealed space formed by the sealing member and having moisture absorbing characteristics which are different from each other.

Consequently, it is possible to obtain an ink jet head unit which serves to prevent a dielectric breakdown of a piezoelectric vibrator through an application of a voltage and has a small size and a high reliability.

### BRIEF DESCRIPTION OF THE DRAWINGS

FIG. 1 is a perspective view showing a whole structure of an ink jet head board according to a first embodiment of the invention,

FIG. 2 is a perspective view showing main parts of a piezoelectric actuator portion and a pressure chamber member according to the first embodiment of the invention,

FIG. 3 is a sectional view showing a main part of the ink jet head board in an orthogonal direction to a direction of supply of an ink according to the first embodiment of the invention,

FIG. 4 is a sectional view showing an ink jet head unit according to the first embodiment of the invention as seen from a front side,

FIG. 5 is a sectional view showing the ink jet head unit according to the first embodiment of the invention as seen from a side,

FIG. 6 is a characteristic chart showing reliabilities of the ink jet head unit according to the first embodiment of the invention and a conventional ink jet head unit,

FIG. 7 is a sectional view showing an ink jet head unit according to a second embodiment of the invention as seen from a side,

FIG. 8 is a sectional view showing an ink jet head unit according to a third embodiment of the invention as seen from a front side,

FIG. 9 is a sectional view showing an ink jet head unit according to a fifth embodiment of the invention as seen from a front side,

FIG. 10 is a sectional view showing the ink jet head unit according to the fifth embodiment of the invention as seen from a side,

FIG. 11 is a characteristic chart showing reliabilities of the ink jet head unit according to the fifth embodiment of the invention and a conventional ink jet head unit,

FIG. 12 is a sectional view showing an ink jet head unit according to a sixth embodiment of the invention as seen from a side, and

FIG. 13 is a sectional view showing an ink jet head unit according to a seventh embodiment of the invention as seen from a side.

### DETAILED DESCRIPTION OF THE PREFERRED EMBODIMENTS

Embodiments of the invention will be described below in detail with reference to the drawings. In these drawings, the same members have the same reference numerals and repetitive description will be omitted. Moreover, the invention is not restricted to the following description but can be properly changed without departing from the scope of the invention.

### First Embodiment

An ink jet head unit has two types for generating a pressure in a pressure chamber. One of them is a type for generating bubbles in a pressure chamber by utilizing Joule's heat and the other is a type for deforming a pressure chamber by a piezoelectric element. These types are used properly depending on a desired performance and uses.

The piezoelectric element in the latter type has a performance for converting a mechanical energy into an electrical energy or converting the electrical energy into the mechanical energy, and a basic structure is a laminated product in which a piezoelectric is interposed between two electrodes in a vertical direction. A typical piezoelectric material to be used for a piezoelectric vibrator includes lead zirconate titanate (Pb(Zr, Ti)O₃) (PZT) to be oxide having a perovskite type crystal structure and PZT to which magnesium, manganese, nickel or niobium is added. In particular, a great piezoelectric displacement is obtained in a <001> axis direction (a C-axis direction) in case of tetragonal system PZT having the perovskite type crystal structure and a <111> axis direction in case of rhombic system PZT.

However, many piezoelectric materials are other polycrystalline substances constituted by a set of crystal grains, and each crystal axis is turned in an unspecified direction. For this reason, a spontaneous polarization Ps is also arranged unspecifically. However, a piezoelectric vibrator is formed in such a manner that a sum of vectors is set in a parallel direction with an electric field. In a piezoelectric actuator according to one configuration of the piezoelectric vibrator (a vibrating plate is provided in the laminated product), when a voltage is applied between both electrodes, a mechanical displacement which is proportional to a magnitude of the voltage is obtained.

With a reduction in sizes of recent electronic apparatuses, a reduction in a size of a piezoelectric vibrator has been required greatly. At the same time, an enhancement in a fineness has been required for obtaining high printing quality. By using a thin film piezoelectric element capable of reducing a volume remarkably as compared with a sintered product which has been conventionally utilized greatly without using the sintered product as a piezoelectric element, it is possible to meet these requirements.

The reason is that precision in etching using a photolithographic technique is limited because a thickness of the sintered product is several tens μm which is greater than a thickness of a thin film piezoelectric vibrator, that is, approximately 3 μm. In order to carry out predetermined etching with high precision, a line width is to be equal to or smaller than the film thickness. By using the thin film piezoelectric element having a small thickness, it is possible to carry out a fine processing. A method of forming the thin film piezoelectric element, for example, a PZT film includes a sputtering method, a CVD method and a sol-gel method. In the respective methods, a thin film piezoelectric element having a high characteristic has been obtained by regulating a film forming condition and devising a heat treating condition.

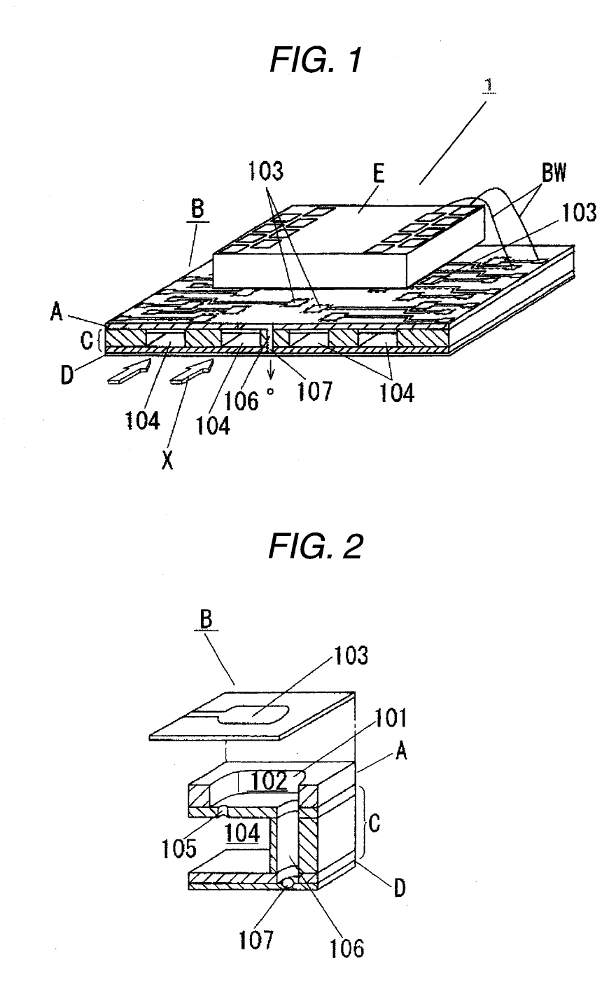

FIG. 1 is a perspective view showing a whole structure of an ink jet head board according to a first embodiment of the invention.

FIG. 2 is a perspective view showing main parts of a piezoelectric actuator portion and a pressure chamber member according to the first embodiment of the invention.

With reference to FIGS. 1 and 2, description will be given to the summary of each component.

A denotes a pressure chamber member. The pressure chamber member A is provided with a pressure chamber opening portion 101 penetrating in a direction of a thickness (a vertical direction). B denotes a piezoelectric actuator portion disposed to cover an opening on one of ends of the pressure chamber opening portion 101 (an upper end in FIG. 2), and C denotes an ink passage member disposed to cover an opening on the other end of the pressure chamber opening portion 101 (a lower end in FIG. 2). The pressure chamber opening portion 101 of the pressure chamber member A is closed by the piezoelectric actuator portion B and the ink passage member C which are positioned on upper and lower parts respectively so that a pressure chamber 102 is formed.

The piezoelectric actuator portion B has a first electrode layer 103 (an individual electrode) positioned almost just above the pressure chamber 102, and a large number of pressure chambers 102 and a large number of first electrode layers 103 are arranged zigzag as is apparent from FIG. 1.

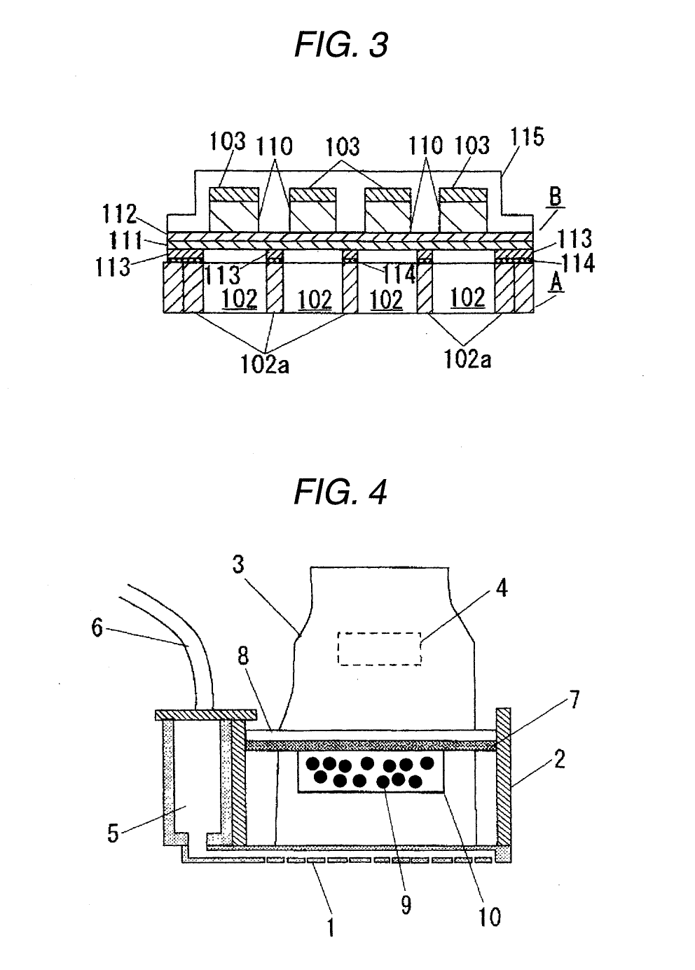

FIG. 3 is a sectional view showing a main part of the ink jet head board in an orthogonal direction to a direction of supply of an ink according to the first embodiment of the invention.

The direction of supply of an ink is shown in an arrow X of FIG. 1.

A structure of the piezoelectric actuator portion B will be described below with reference to FIG. 3.

In FIG. 3, the pressure chamber member A having four pressure chambers 102 arranged in an orthogonal direction and the actuator portion B are shown by reference.

In FIG. 3, 103 denotes a first electrode layer positioned almost just above the pressure chamber 102 as described above. 110 denotes a piezoelectric layer provided on one surface of the electrode layer 103 (a lower side in FIG. 3). 112 denotes a second electrode layer (a common electrode) which is provided on one surface of the piezoelectric layer 110 (a lower side in FIG. 3) and is common to all of the piezoelectric layers 110.

111 denotes a vibrating layer provided on one surface (a lower side in FIG. 3) of the second electrode layer 112 and displaced in a direction of a layer thickness by a piezoelectric effect of the piezoelectric layer 110 to carry out a vibration. 113 denotes an intermediate layer (a vertical wall) provided on one surface of the vibrating layer 111 (a lower side in FIG. 3) and positioned above a partition wall 102a for mutually partitioning each pressure chamber 102.

The first electrode layer 103, the piezoelectric layer 110 and the second electrode layer 112 are sequentially laminated to constitute a piezoelectric element. Moreover, the vibrating layer 111 is provided on a surface at the second electrode layer 112 side. A protecting film 115 is formed to cover the whole components.

In FIG. 3, 114 denotes an adhesive for bonding the pressure chamber member A to the actuator portion B, and the intermediate layer 113 serves to increase a distance between an upper surface of the pressure chamber 102 and a lower surface of the vibrating layer 111 in such a manner that the adhesive 114 does not stick to the vibrating layer 111 but the vibrating layer 111 causes a predetermined displacement and vibration also in the case in which a part of the adhesive 114 is protruded outward from the partition wall 102a in the bonding using the adhesive 114.

Thus, it is preferable that the pressure chamber member A should be bonded through the intermediate layer 113 to a side surface of the vibrating layer 111 of the actuator portion B which is opposite to the second electrode layer 112. However, the pressure chamber member A may be directly bonded to the side surface of the vibrating layer 111 which is opposite to the second electrode layer 112.

Returning to FIGS. 1 and 2, description will be continuously given.

The ink passage member C has a common fluid chamber 104 shared between the pressure chambers 102 arranged in the direction of supply of an ink, a supply port 105 for supplying the ink in the common fluid chamber 104 to the pressure chamber 102, and an ink passage 106 for discharging the ink in the pressure chamber 102.

D denotes a nozzle plate. A nozzle hole 107 communicating with the ink passage 106 is formed on the nozzle plate D. Moreover, E denotes an IC chip. A voltage is supplied from the IC chip E to the first electrode layer (the individual electrode) 103 through a bonding wire BW.

The ink head unit according to the first embodiment of the invention is constituted by using the ink jet head board having the structure. Detailed description will be given with reference to the drawings.

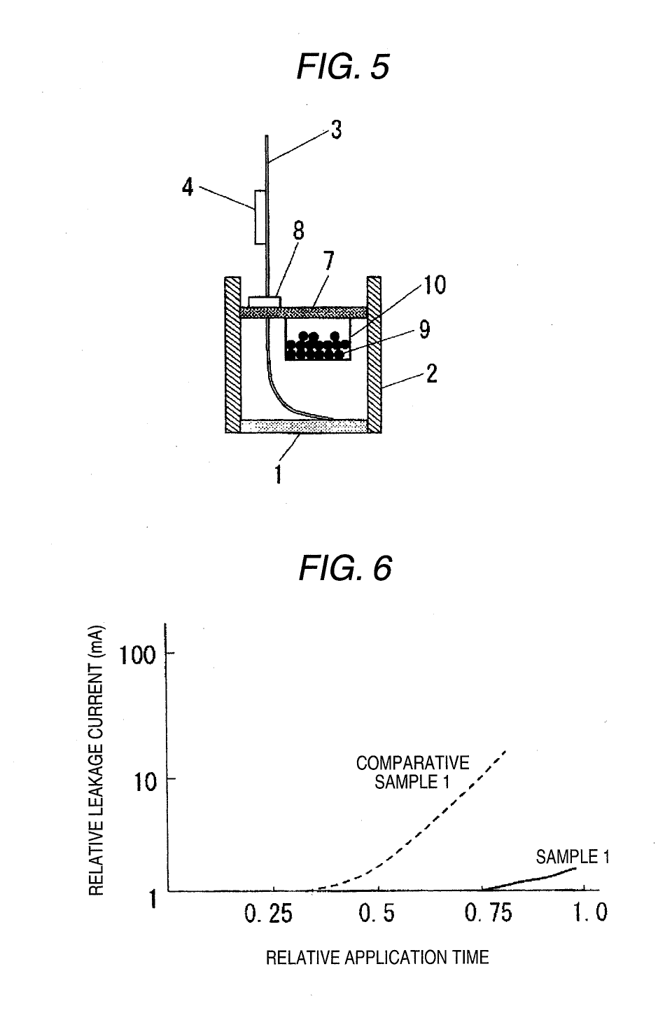

FIG. 4 is a sectional view showing the ink jet head unit according to the first embodiment of the invention as seen from a front side, and FIG. 5 is a sectional view showing the ink jet head unit according to the first embodiment of the invention as seen from a side.

In FIGS. 4 and 5, 1 denotes an ink jet head board on which a large number of nozzles, the pressure chamber and the piezoelectric actuator described above are formed (the details are omitted to prevent the drawings from being complicated), 2 denotes a head base bonded to the ink jet head board 1 and serving to support the ink jet head board 1, 3 denotes a flexible printed board connected to the ink jet head board 1 and serving to transmit a driving signal for driving the piezoelectric actuator, 4 denotes a driving IC mounted on the flexible printed board 3, 5 denotes an ink chamber for supplying an ink to carry out printing, and 6 denotes an ink tube for supplying, to the ink chamber 5, the ink to carry out the printing. 7 denotes a sealing cap, and 8 denotes an adhesive resin for bonding the head base 2 to the sealing cap 7. 9 denotes a drying agent for adsorbing moisture of a sealed space (a sealed space), and 10 denotes a polymer film having a high moisture permeability for separating the drying agent from other members.

In FIG. 4, the head base 2 is disposed on the ink jet headboard 1. In FIG. 5, moreover, the head base 2 is disposed on a side surface of the ink jet head board 1.

The ink jet head board 1 and the flexible printed board 3 are electrically connected to each other through an anisotropic conductive film, for example. The ink for carrying out the printing is supplied by the ink chamber 5 and the ink tube 6. Then, the flexible printed board 3 connected to the ink jet head board 1 transmits a signal of the driving IC 4 to the ink jet head board 1, and the piezoelectric actuator portion B vibrates to carry out the printing in response to the signal.

In order to protect the piezoelectric actuator disposed on the ink jet head board 1 from moisture, there is employed a structure in which the head base 2 and the sealing cap 7 are bonded to each other with the adhesive resin 8 and are thus closed and sealed, and plural kinds of drying agents 9 having different moisture absorbing characteristics from each other are disposed in the closed space (sealed space) (A specific example of the drying agent 9 will be described below in detail).

The drying agent 9 is partitioned with the polymer film 10 having a high moisture permeability, for example, polyethylene, polypropylene or polyvinylidene chloride so that the drying agent 9 and the piezoelectric actuator are prevented from directly coming in contact with each other, and furthermore, the moisture entering the closed space passes through the polymer film 10 and is adsorbed into the drying agent 9. Therefore, an inner part of the closed space can be brought into a low humidity state.

In the first embodiment, thus; there is employed the structure in which the drying agent 9 is partitioned with the polymer film 10 and is substantially supported by the sealing cap 7 in the closed space.

The adhesive resin 8 to be used is not particularly restricted but may be of such a type as to carry out curing and bonding with an ultraviolet radiation (UV) or such a type as to carry out the curing and bonding by heating or leaving at an ordinary temperature. Referring to the drying agent 9, a performance can be enhanced by mixing two kinds of drying agents according to the invention and an increase in a drying capacity is limited. For this reason, it is preferable that the adhesive resin 8 should have a lower moisture permeability.

It is preferable to use a material having a low moisture permeability for the head base 2 and the sealing cap 7. The head base 2 can constitute a part of the ink passage. In general, therefore, a polymer resin having a property indicative of a wettability to an ink (which will be hereinafter referred to as a wettability) and an excellent processability, for example, a denatured polyethylene oxide resin is used. It is also possible to use a polymer resin having a lower humidness than the denatured polyethylene oxide resin such as a cycloolefin polymer.

Furthermore, it is also possible to utilize a head base having a moisture permeability improved by coating a polymer resin surface with oxide such as a nickel (Ni) film having an excellent wettability to an ink, a titanium film, their alloyed film, a silicon oxide film (SiO₂ film), a silicon nitride film (SiN) film or an alumina (Al₂O₃) film in a thickness of several μm to several tens μm by using a sputtering method or a plating method.

Moreover, there is a small possibility that the sealing cap 7 might directly come in contact with the ink. Therefore, it is not necessary to take the wettability into consideration, and it is preferable to use a material for completely blocking moisture, for example, a metal or a glass.

In order to maintain an initial performance of the drying agent 9, it is necessary to take care not to adsorb moisture in the air at a step of sealing the drying agent 9. At a serial sealing step of attaching the drying agent 9 to the closed space, applying and sealing a resin and curing the resin, however, a time of approximately several minutes to several tens minutes passes. In the meantime, the moisture in the air is adsorbed. For this reason, a moisture adsorbing capability of the drying agent 9 is deteriorated. In addition, the moisture in the air is not constant and is changed greatly depending on a season or an environment. Even if the sealing step is managed, therefore, it is hard to maintain the performance of the drying agent 9 to be constant without a variation.

Accordingly, it is preferable to carry out the sealing step of attaching the drying agent 9 in a glove box managed at a low humidity. Consequently, it is possible to prevent the moisture adsorbing capability of the drying agent 9 from being deteriorated, and furthermore, to prevent a variation in the performance of the individual drying agent 9 from being caused. In addition, it is preferable that an atmosphere in the glove box should not be general air or nitrogen but a gas having a greater molecular weight than water, for example, argon, krypton or xenon. If the heavier gas than the water can be filled in the closed space, the influence of the moisture can be lessened because the heavier gas than the water is stored in a bottom portion of an inner part of the ink jet head unit even though the water enters the closed space.

In general IC packaging and sealing for organic EL, the water does not enter from peripheral members of an element at all because the peripheral members are formed of a metal and a glass respectively, and the water enters from only a resin connecting portion. Accordingly, the drying agent is required in a very small amount for the sealing, and a drying capability is a more important parameter than a drying capacity in a selection of the drying agent.

On the other hand, in the ink jet head, the drying agent can be provided in only a limited space in respect of the structure of the apparatus. As described above, moreover, a low humidity at a dew point of −40□ or less is required for preventing a dielectric breakdown of the piezoelectric vibrator, thereby hindering the generation of a leakage current. For a material of the head base 2 for surrounding the piezoelectric vibrator, furthermore, it is hard to use a metal in respect of a wettability, a processability and a cost property. Moreover, it is impossible to use a glass in respect of the processability and a fragility. Accordingly, a polymer resin which can be fabricated, for example, a denatured polyethylene oxide resin is often used as the material of the head base 2.

In the head base 2, the water cannot be blocked perfectly but a large amount of moisture enters from the member. For this reason, there is required a larger drying capacity than a drying agent to be used for the IC packaging or the organic EL.

A silica gel and a molecular sieve (zeolite) which serve to adsorb moisture by a physical action are very chemically stable and their states are rarely changed due to the absorption. In general, however, they have comparatively small drying capacities. On the other hand, calcium oxide, calcium chloride and magnesium chloride which adsorb the moisture by the chemical action have large drying capacities as compared with a physical adsorption and change states by a moisture adsorption, and the calcium oxide has a volume increased and the calcium chloride and the magnesium chloride are liquefied by a deliquescent property.

In a drying agent for sealing of the ink jet head, it is demanded that the state is not changed before and after the adsorption, and furthermore, a drying capacity is large. It is hard to satisfy the demand with one kind of drying agent. In the embodiment, therefore, at least two kinds of drying agents having different properties are selected and mixed to make the most of advantages of the respective drying agents and to compensate for defects of the respective drying agents. More specifically, it is possible to make the most of the advantages of the respective drying agents and to compensate for the defects. Therefore, it is possible to use a drying agent having a large drying capacity. Consequently, it is possible to implement a drying agent which has a high stability and a high drying capability consistent with each other and is suitably used for the drying agent for sealing of the ink jet head.

By using the drying agent, moreover, it is possible to produce an advantage that a low humidity state for preventing a piezoelectric vibrator from causing a dielectric breakdown to generate the flow of a leakage current can be maintained for a long time. Thus, the drying agent is suitable for the field of an ink jet recording apparatus which discharges an ink to form an image by utilizing a displacement of the piezoelectric vibrator.

By using the drying agent as the drying agent for sealing of the ink jet head unit, it is possible to reduce moisture entering the piezoelectric vibrator for a long period of time. Therefore, it is possible to implement an ink jet head unit which can maintain the low humidity state for a long time, can prevent the dielectric breakdown of the piezoelectric vibrator from being caused by the moisture and can inhibit the leakage current from flowing due to the dielectric breakdown of the piezoelectric vibrator, and can achieve a high reliability. Since the structure is simple, moreover, a size of the ink jet head unit can be reduced.

According to the ink jet head unit in accordance with the embodiment, therefore, it is possible to implement an ink jet head unit which removes the moisture to eliminate the influence of the moisture on the piezoelectric vibrator and has a small size and a high reliability, and to implement an ink jet recording apparatus capable of maintaining stable printing quality for a long period of time by loading the ink jet head unit.

The ink jet head unit (which will be hereinafter referred to as a sample 1) having the structure of the sealing portion according to the first embodiment is fabricated and a reliability is compared with that of an ink jet head unit (which will be hereinafter referred to as a comparative sample 1) having a conventional structure.

FIG. 6 is a characteristic chart showing the reliabilities of the ink jet head unit according to the first embodiment of the invention and the conventional ink jet head unit.

FIG. 6 shows a relationship between a voltage application time and a leakage current. An evaluation of the reliability is carried out in an environment at a temperature of 40□ and a humidity of 60%, and a voltage of 30V is continuously applied to measure a current which flows.

In the sample 1, denatured polyethylene oxide resin sealing is used for the head base 2, an aluminum (Al) metal is used for the sealing cap 7, and a fluoric resin is used for the adhesive resin 8 fixing them. The molecular sieve and the calcium chloride are mixed in a weight ratio of 1 to 1 and are thus used for the drying agent 9 to be filled in the closed space. A polyethylene film is used for the polymer film 10 to cover the drying agent 9 and is connected to the sealing cap 7, thereby preventing the drying agent 9 from coming in contact with the piezoelectric vibrator. An ultraviolet (UV) resin is used for bonding the polymer film 10 (the polyethylene film) to an aluminum (Al) metal to be the sealing cap 7.

The comparative sample 1 has the same structure as that of the sample 1 except that a molecular sieve in the same amount (a weight obtained by adding the molecular sieve in the sample 1 and the calcium chloride) is used as the drying agent.

In FIG. 6, it is apparent from a comparison between reliability evaluation results of the sample 1 and the comparative sample 1 that an increase in a leakage current is not observed for a long period of time in the sample 1. In other words, in the sample 1, it is apparent that the influence of the moisture on the piezoelectric actuator can be eliminated and high quality printing can be maintained for a longer time as compared with the comparative sample 1 also in an environment having a high temperature and a high humidity.

In the first embodiment, the reliability in a continuous electrification has been evaluated. Also in a preservation test for applying a voltage to evaluate a leakage current after a preservation for a long period of time in an environment of a further high temperature and humidity of 60□ and 90% or 85□ and 85, for example, a higher reliability can be obtained in the sample 1 than that in the comparative sample 1.

More specifically, in the comparative sample 1 fabricated by filling 1 g of the molecular sieve as the drying agent, an increase in a leakage current is observed after 150 hours when the preservation is carried out in an environment of 85□ and 85%. On the other hand, in the sample 1 in which 0.5 g of the molecular sieve and 0.5 g of the calcium chloride are filled as the drying agent 9, the increase in the leakage current is observed after 250 hours. Also in the preservation test, accordingly, it is apparent that the ink jet head unit according to the first embodiment can have a higher reliability than that in the ink jet head unit with the conventional structure.

Description will be given to a result of a comparison for amounts of water absorption depending on the types of the drying agent.

Table 1 shows an amount of moisture absorbed before the ink jet head unit fabricated by sealing various drying agents generates the leakage current.

TABLE 1

| | | Water Absorbing |
|---|---|---|
| | Drying Agent | Critical Amount |
| Conventional | Silica Gel (Type-P) | 2% |
| Drying Agent | Molecular Sieve (Type-P) | 16% |
| | Calcium Chloride | 18% |
| | (Type-C) | |
| | Calcium oxide (Type-C) | 10% |
| | Calcium Chloride | 18% |
| | (Type-C) | |
| | Calcium oxide (Type-C) | |
| Inventive | Molecular Sieve (Type-P) | 25% |
| Drying Agent | Calcium Chloride | |
| | (Type-C) | |
| | Molecular Sieve (Type-P) | 20% |
| | Calcium oxide (Type-C) | |

A weight difference of a whole ink jet head unit which is made before and after an environmental test at 85□ and 85% is regarded as an amount of moisture adsorbed by the drying agent. The ink jet head unit is periodically taken out of a testing apparatus to measure the leakage current and the weight, and the amount of the adsorbed water is set to be a water absorbing critical amount of the drying agent when the leakage current is generated.

The water absorbing critical amount is represented by an increasing rate (%) per unit mass of the drying agent. The ink jet head unit used in the evaluation has the same structure as that shown in FIG. 4, and only the structure of the drying agent 9 is changed. In the drying agent 9, a mixing ratio of two kinds of drying agents which are mixed is entirely set to be 1 to 1. Moreover, a volume of the calcium oxide is increased to be approximately three times as large as possible at a maximum with the adsorption of the moisture. In the case in which the calcium oxide is actually used, accordingly, the increase in the volume is to be counted on. By counting on the increase in the volume, an amount in which the calcium oxide can be filled is to be ⅓ of that in the increase in the volume. The amount of moisture absorption of the calcium oxide shown in the (Table 1) is corrected in consideration of the increase in the volume.

Apparently from FIG. 6 and the result of the (Table 1), it is possible to have a moisture adsorbing capability which is equal to or greater than a value obtained by adding and averaging capabilities of the individual drying agents in combination with at least two kinds of drying agents, and to enhance a drying capability by using two kinds of drying agents, thereby increasing the amount of the adsorbed moisture before the generation of the leakage current in the ink jet head unit according to the first embodiment. More specifically, in the ink jet head unit according to the first embodiment, it is implied that a drying agent obtained by combining a drying agent having such a characteristic as to physically adsorb the moisture and a drying agent having such a characteristic as to chemically adsorb the moisture is used for sealing the ink jet head unit and a high reliability which cannot be obtained in the conventional ink jet head unit can be thus acquired.

In the (Table 1), the drying agent having such a characteristic as to physically adsorb the moisture is indicated as Type-P and the drying agent having such a characteristic as to chemically adsorb the moisture is indicated as Type-C.

It is a matter of course that the drying agent has different amounts of moisture which can be adsorbed depending on the type, and furthermore, the capability is varied depending on an external environment. For example, in case of the molecular sieve to be the drying agent which has such a characteristic as to physically adsorb the moisture, it has a moisture adsorbing performance of 22% with respect to a unit mass in a high humidity environment, and has a moisture adsorbing capability of approximately 16% in order to maintain a dew point of −40□, for example. Also in case of the calcium chloride to be the drying agent having such a characteristic as to chemically adsorb the moisture, similarly, it has an adsorbing capability of 100% in a high humidity environment and has an adsorbing capability of approximately 17% at most in order to maintain the dew point of −40□, and furthermore, a substantial adsorbing capability is further reduced because of a deliquescent property. As a matter of course, a maximum amount of the adsorbed moisture in the high humidity environment with the drying agents mixed is obtained by averaging the individual capabilities.

However, it is demanded that a necessary environment has a very low humidity, that is, the dew point of −40□ and the drying agent itself has neither a volume expansion nor a deliquescent property because an installation space for the drying agent is limited. For the drying agent to be used for sealing the ink jet head, therefore, two kinds of drying agents, that is, the drying agent having such a characteristic as to physically adsorb the moisture and the drying agent having such a characteristic as to chemically adsorb the moisture are mixed to improve and compensate for individual defects. Thus, it is possible to produce an advantage which exceeds an advantage by a simple addition.

The synergistic effect is obtained by causing the drying agent having such a characteristic as to physically adsorb the moisture to prevent a deterioration in a moisture absorbing capability due to a liquefaction in the case in which the drying agent having such a characteristic as to chemically adsorb the moisture has the deliquescent property.

While only the case in which the two kinds of drying agents are mixed has been taken as an example, it has been confirmed that the same advantages can be obtained by mixing at least three kinds of drying agents. Although the materials of the drying agents to be mixed are not particularly restricted, moreover, it is possible to produce more preferable results by mixing a drying agent which has a comparatively large adsorbing capacity and chemically adsorbs moisture and a drying agent which does not have a very large adsorbing capability, has a small change in a state before and after the adsorption and physically adsorbs the moisture. More specifically, the more preferable results depend on how to compensate for the defects of the respective drying agents to be mixed together, and a selection of a material therefor is important.

### Second Embodiment

In a second embodiment, description will be given to another ink jet head unit according to the invention.

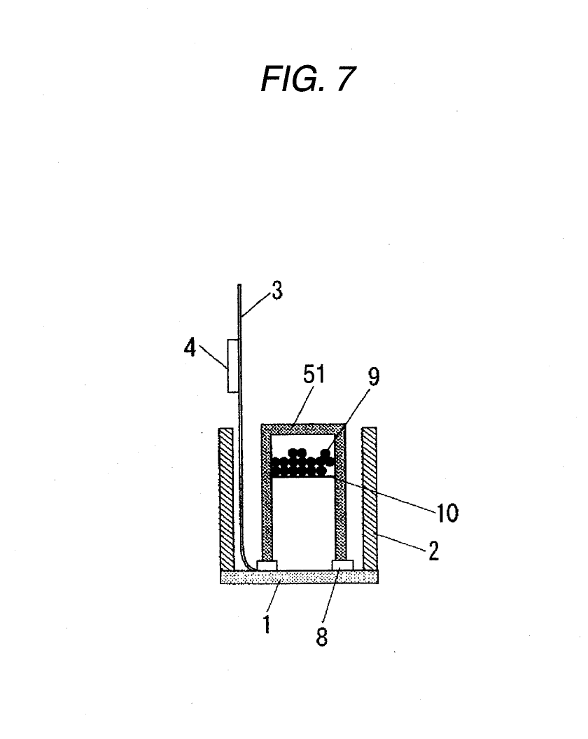

FIG. 7 is a sectional view showing the ink jet head unit according to the second embodiment of the invention as seen from a side.

In the second embodiment, differently from the case shown in FIG. 5 according to the first embodiment, a flexible printed board 3 is electrically connected to an ink jet head board 1 having a piezoelectric actuator formed thereon at an outside where the ink jet head board 1 is sealed and closed. The electrical connection is carried out by thermocompression bonding using an anisotropic conductive film (ACF), for example.

An electrical contact (not shown) provided on an end of the flexible printed board 3 is bonded to the ink jet head board 1, and a driving signal output from a driving IC 4 is propagated over a circuit pattern formed on the ink jet head board 1 through the bonding portion and is supplied to the piezoelectric actuator.

In general, the circuit pattern formed on the ink jet head board 1 is constituted by a very thin metal layer such as Al or Cu. By thus providing an internal sealing cap 51 through an adhesive resin 8 in a region having a small step on a surface, therefore, it is possible to block an immersion route for moisture. Thus, a sealing performance can be considerably enhanced.

The ink jet head unit according to the second embodiment has the same structure as that in the first embodiment except that the flexible printed board 3 is perfectly separated from a closed space formed by the internal sealing cap 51.

Also in the ink jet head unit according to the second embodiment which has the structure, it is possible to obtain the same advantages as those in the ink jet head unit according to the first embodiment. The ink jet head unit subjected to the sealing has a high reliability. More specifically, also in the ink jet head unit according to the second embodiment, it is possible to prevent a dielectric breakdown of a piezoelectric vibrator from being caused by moisture. Thus, it is possible to implement an ink jet head unit which achieves a high reliability. Since the structure is simple, moreover, a size of the ink jet head unit can be reduced.

According to the ink jet head unit in accordance with the second embodiment, therefore, it is possible to implement an ink jet head unit in which moisture is removed to eliminate the influence of the moisture on the piezoelectric actuator and which has a small size and a high reliability. By loading the ink jet head unit, it is possible to implement an ink jet recording apparatus capable of maintaining stable printing quality for a long period of time.

In the second embodiment, an immersion of the moisture from the flexible printed board 3 and an interface including the flexible printed board 3 is lessened as compared with the case of the first embodiment described above. For this reason, it is possible to obtain an advantage that a load to be applied to a drying agent 9 constituted by a drying agent having such a characteristic as to physically adsorb the moisture and a drying agent having such a characteristic as to chemically adsorb the moisture is reduced and a long-term reliability can further be enhanced as compared with the sealing structure described in the first embodiment. With the structure, it is possible to obtain a higher long-term reliability by attaching a drying agent having a higher performance into the closed space of the ink jet head.

### Third Embodiment

In a third embodiment, description will be given to yet another ink jet head unit according to the invention.

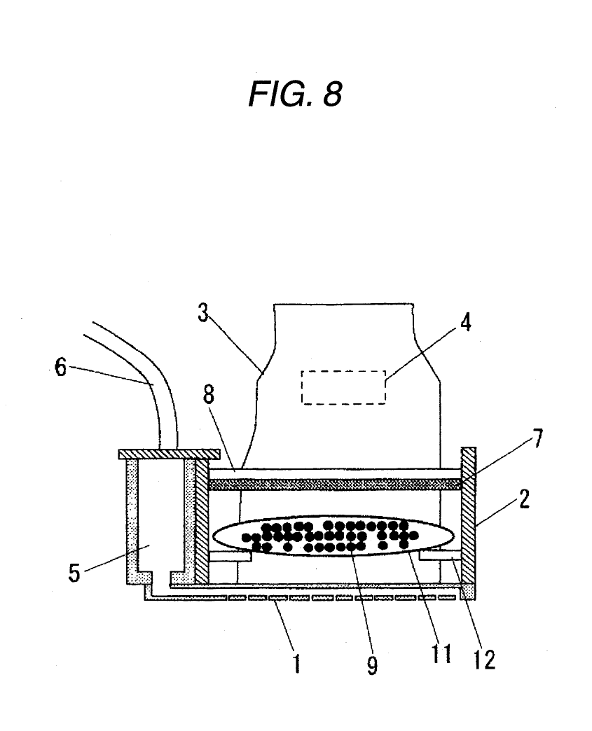

FIG. 8 is a sectional view showing the ink jet head unit according to the third embodiment of the invention as seen from a front side.

In the ink jet head unit according to the third embodiment, a drying agent 9 constituted by a drying agent having such a characteristic as to physically adsorb moisture and a drying agent having such a characteristic as to chemically adsorb the moisture is covered with a wrapping material 11 for wrapping the drying agent 9. Furthermore, a locking table 12 for holding the wrapping material 11 is disposed on a head base 2 in such a manner that the drying agent 9 filled in the wrapping material 11 does not directly come in contact with a piezoelectric actuator (not shown) provided on an ink jet head board 1, that is, prevents a motion of a piezoelectric element from being disturbed.

In the third embodiment, thus, the bag (the wrapping material 11) filled with the drying agent 9 is supported in a hollow portion of a closed space formed by an ink jet head board 1, the head base 2, and a sealing cap 7 (and an adhesive resin 8).

By the structure, an area (or a volume) on which a gas filled in the closed space and the drying agent 9 come in contact with each other is increased so that an inner part of the closed space can be dried efficiently.

The ink jet head unit according to the third embodiment basically has the same structure as that in the first embodiment except that the wrapping material 11 wrapping the drying agent 9 and the locking table 12 are provided.

For the wrapping material 11, it is possible to use the same material as the polymer film 10 described in the first embodiment, and it is preferable to use a material having a comparatively high moisture permeability, for example, polyethylene, polypropylene or polyvinylidene chloride.

Also in the ink jet head unit according to the third embodiment which has the structure, it is possible to obtain the same advantages as those in the ink jet head unit according to the first embodiment. The ink jet head unit subjected to the sealing has a high reliability. More specifically, also in the ink jet head unit according to the third embodiment, it is possible to prevent a dielectric breakdown of a piezoelectric vibrator from being caused by moisture. Thus, it is possible to implement an ink jet head unit which achieves a high reliability. Since the structure is simple, moreover, a size of the ink jet head unit can be reduced.

According to the ink jet head unit in accordance with the third embodiment, therefore, it is possible to implement an ink jet head unit in which moisture is removed to eliminate the influence of the moisture on the piezoelectric actuator and which has a small size and a high reliability. By loading the ink jet head unit, it is possible to implement an ink jet recording apparatus capable of maintaining stable printing quality for a long period of time.

Furthermore, the ink jet head unit according to the third embodiment has an advantage that an assembling property is excellent. More specifically, in the structure described in the first embodiment, the polymer film 10 enveloping the drying agent 9 is to be bonded to the sealing cap 7 with an ultraviolet (UV) resin. On the other hand, in the sealing structure described in the third embodiment, it is sufficient that the drying agent 9 is simply attached into the closed space before the sealing cap 7 is bonded to the head base 2. Therefore, it is possible to easily obtain a sealing structure without inhibiting an operation of the piezoelectric actuator.

In the foregoing, the drying agent 9 covered with the wrapping material 11 is fixed by means of the locking table 12 and is prevented from directly coming in contact with the piezoelectric actuator. However, it is also possible to fix a mesh-like metal plate at both sides of the head base 2 and to attach the drying agent 9 filled in a bag onto the metal plate, for example. In order to remove the moisture to eliminate the influence of the moisture on the piezoelectric actuator and to maintain a high reliability, it is important to dispose the drying agent 9 without perfectly separating the space including the piezoelectric actuator from the drying agent 9 filled in the bag. For this purpose, as described in the third embodiment, it is important to prevent the space having the piezoelectric actuator attached thereto and the space having the drying agent 9 disposed therein from being perfectly independent by utilizing the locking table or the mesh-like metal plate.

### Fourth Embodiment

In a fourth embodiment, description will be given to a further ink jet head unit according to the invention.

In the fourth embodiment, a drying agent 9 obtained by mixing magnesium chloride and magnesium oxide is disposed in a closed space to constitute an ink jet head unit.

The ink jet head unit according to the fourth embodiment basically has the same structure as that in the first embodiment except that the drying agent 9 obtained by mixing the magnesium chloride and the magnesium oxide is provided.

Also in the ink jet head unit according to the fourth embodiment which has the structure, it is possible to obtain the same advantages as those in the ink jet head unit according to the first embodiment. The ink jet head unit subjected to sealing has a high reliability. More specifically, also in the ink jet head unit according to the fourth embodiment, it is possible to prevent a dielectric breakdown of a piezoelectric vibrator from being caused by moisture. Thus, it is possible to implement an ink jet head unit which achieves a high reliability. Since the structure is simple, moreover, a size of the ink jet head unit can be reduced.

According to the ink jet head unit in accordance with the fourth embodiment, therefore, it is possible to implement an ink jet head unit in which moisture is removed to eliminate the influence of the moisture on a piezoelectric actuator and which has a small size and a high reliability. By loading the ink jet head unit, it is possible to implement an ink jet recording apparatus capable of maintaining stable printing quality for a long period of time.

The magnesium chloride has such a performance as to chemically adsorb moisture and has a larger moisture adsorbing capacity than the calcium chloride, that is, 200% of a drying capacity or more. However, the magnesium chloride has a deliquescent property in the same manner as the calcium chloride. For this reason, it is hard to singly use the magnesium chloride as the drying agent 9.

By mixing the magnesium chloride and the magnesium oxide together, however, the magnesium oxide acts as a caking agent. Even if the moisture is adsorbed, therefore, it is possible to prevent the magnesium chloride from deliquescing. Accordingly, it is possible to maintain a stable state having no deliquescent property also after the adsorption of the moisture while maintaining the drying capacity of the magnesium chloride. Consequently, the magnesium oxide can be used as a drying agent to be filled in the ink jet head.

Thus, the magnesium oxide acts as the caking agent when the magnesium chloride deliquesces, and is strictly hard to be referred to as a drying agent. However, the magnesium oxide has similar functions and advantages as those of the structure described in the first embodiment.

The drying agent having the function is generally known and is sold in a trade name of “OZO” or “NISSO DRY”, for example.

As described above, the ink jet head unit has a sealing structure in which the material to be used is greatly limited in respect of a wettability and an immersion also progresses from an adhesive resin, and therefore, it is impossible to perfectly eliminate the immersion of the moisture and it is optimum to remove the approaching moisture with the drying agent. In the sealing of the ink jet head limited on a spatial basis, however, a drying agent such as a silica gel, calcium oxide or polyvinyl alcohol which has been disclosed has a very low performance, and a long-term reliability has not been obtained yet.

As described in the first to fourth embodiments, the most important element in the sealing of the ink jet head unit is the drying agent to be filled therein, and a lifetime of the ink jet head greatly depends on a selection thereof.

In a method disclosed in the (JP-A-10-305578 Publication), if an external environment is sufficiently taken into consideration to carry out sealing in an environment having a low humidity, a dry fluid is filled so that the influence of the moisture can be perfectly eliminated in the early stage of the sealing. However, the moisture infiltrates from an adhesive resin connecting a sealing cap with the passage of time. For this reason, an initial condition cannot be maintained. By employing a resin having a low moisture permeability, it is possible to reduce an amount of penetration of the moisture. However, it is difficult to perfectly reduce the moisture permeability of the resin. After all, the influence of the moisture is made and a dielectric breakdown of a piezoelectric vibrator is caused so that a leakage current flows.

In a method of causing a dry fluid to continuously flow to a piezoelectric vibrator which has been disclosed in the (JP-A-2004-322605), moreover, there are required equipment for generating a dry gas and a tube for leading the dry gas to individual heads. The method is not suitable for a reduction in a size.

In a method disclosed in the (JP-A-11-300957), infiltrating moisture can be removed with a moisture absorbent as compared with the method disclosed in the (JP-A-H10-305578). Therefore, it is possible to correspondingly maintain a reliability for a longtime. However, a drying agent and heat generating means are used together. Therefore, a structure is complicated, and furthermore, a size cannot be reduced. Moreover, a moisture absorbent such as a silica gel, a slaked lime or MgF₂ which is taken as an example has a low performance, that is, a low drying performance and a low drying capability. Therefore, it is impossible to hold, for a long time, an environment at a dew point of −40□ in which a leakage current of a piezoelectric vibrator can be perfectly suppressed.

According to the structures described in the first to fourth embodiments of the invention, however, it is possible to solve the problems of the prior arts.

As described above in detail, the first to fourth embodiments include the following invention.

The ink jet head unit according to the embodiments comprises a pressure chamber for discharging an ink with a pressure change, a piezoelectric vibrator provided in the pressure chamber and serving to apply a pressure to the pressure chamber, a sealing member for sealing a space including at least the piezoelectric vibrator, and plural kinds of drying agents disposed in a sealed space formed by the sealing member and having moisture absorbing characteristics which are different from each other.

The drying agent is constituted by a plurality of components. By making the most of merits of each drying agent component, therefore, it is possible to compensate for demerits of another drying agent component. Consequently, it is possible to implement a drying agent in which a high stability and a high drying capability are consistent with each other and to enhance a performance of the drying agent. Thus, it is possible to suppress the influence of the moisture on the piezoelectric vibrator for a long period of time, thereby preventing a dielectric breakdown of the piezoelectric vibrator from being caused by an application of a voltage.

In the embodiment, moreover, the drying agent is constituted by mixing a first drying agent having such a characteristic as to physically adsorb moisture, and a second drying agent having such a characteristic as to chemically adsorb the moisture. By mixing and using these two kinds of drying agents, it is possible to enhance a drying capacity of the drying agent, thereby suppressing the influence of moisture for a long period of time. Consequently, it is possible to prevent the dielectric breakdown of the piezoelectric vibrator from being caused by the application of the voltage.

In the embodiment, furthermore, the first drying agent is set to be a molecular sieve. By using the molecular sieve as the first drying agent, it is possible to enhance the drying capacity of the drying agent, thereby suppressing the influence of the moisture for a long period of time. Consequently, it is possible to prevent the dielectric breakdown of the piezoelectric vibrator from being caused by the application of the voltage.

In the embodiment, moreover, the second drying agent is calcium oxide, calcium chloride or magnesium chloride. The drying agents can absorb a larger amount of moisture as compared with the drying agent for physically adsorbing the moisture. A change in a state of a drying agent for chemically adsorbing the moisture is suppressed with the drying agent for physically adsorbing the moisture. Consequently, it is possible to obtain a function of maintaining a drying capability for a long period of time.

In the embodiment, furthermore, the drying agent is disposed in the sealed space in a bag filling state. Consequently, the piezoelectric vibrator and the drying agent do not directly come in contact with each other. Therefore, a piezoelectric performance can be prevented from being badly influenced and the drying agent can easily be attached. Thus, it is possible to easily prevent the dielectric breakdown of the piezoelectric vibrator from being caused by the application of the voltage without deteriorating quality.

In the embodiment, moreover, the bag filled with the drying agent is disposed separately from the ink jet head board. Consequently, the piezoelectric vibrator and the drying agent do not directly come in contact with each other. Therefore, a piezoelectric performance can be prevented from being badly influenced and the drying agent can easily be attached. Thus, it is possible to easily prevent the dielectric breakdown of the piezoelectric vibrator from being caused by the application of the voltage without deteriorating quality.

In the embodiment, furthermore, the bag filled with the drying agent is supported in a hollow portion of the sealed space. Consequently, an area (or a volume) on which a filled gas and the drying agent come in contact with each other in the sealed space is increased so that an inner part of the sealed space can be dried efficiently.

In the embodiment, moreover, the bag filled with the drying agent is constituted by a polymer film. Consequently, it is possible to dry the sealed space without causing the drying agent to directly come in contact with the ink jet head board.

In the embodiment, furthermore, at least a part of a member constituting the sealed space is constituted by a resin. Consequently, it is possible to use an inexpensive head base which is well fitted to an ink (has a high wettability) and is excellent in a processability. Thus, it is possible to constitute an inexpensive ink jet head unit of high quality.

An ink jet recording apparatus according to the embodiment of the invention loads the ink jet head unit and has a function of stabilizing printing quality for a long time.

A method of manufacturing an ink jet head unit according to the embodiment of the invention comprises a head body portion forming step of forming a head body portion including a pressure chamber for discharging a supplied ink from an opening portion with a pressure change, an ink jet head board forming step of forming a piezoelectric vibrator for applying a pressure to the pressure chamber to form an ink jet head board on one surface side of the pressure chamber in the head body portion, and a sealing step of sealing a space including a drying agent constituted by at least two kinds of different components and the piezoelectric vibrator to form a sealed space together with the ink jet head board, wherein the drying agent is disposed to carry out sealing in a drying gas atmosphere at the sealing step. Consequently, the moisture is less adsorbed with the drying agent in an early stage as compared with the case in which the drying agent is filled in the air. Therefore, a large drying capacity can be maintained.

In the embodiment, moreover, the drying gas is set to be a gas having a greater molecular weight than water. Consequently, an inner part of the sealed space is filled with a gas having a greater mass than the moisture. Also in the case in which the moisture infiltrates into the sealed space, therefore, the piezoelectric vibrator disposed in the bottom portion of the head unit is not surrounded by the moisture but the heavy gas. Therefore, it is possible to reduce the influence of the moisture.

### Fifth Embodiment

In the first to fourth embodiments, the description has been given to the example in which the drying agent to be filled in the ink jet head unit is constituted by the drying agent having two characteristics (more specifically, the drying agent obtained by combining the drying agent having such a characteristic as to physically adsorb the moisture and the drying agent having such a characteristic as to chemically adsorb the moisture).

As a method of reducing the influence of the moisture in the ink jet head unit as greatly as possible and maintaining a high reliability, there has been proposed a method of covering a piezoelectric vibrator with a protecting member impregnated with an insulating fluid as is disclosed in JP-A-2000-43258 Publication, for example, in addition to the patent publications described above.

According to a technique disclosed in the JP-A-2000-43258 Publication, the piezoelectric vibrator is covered with the protecting member impregnated with the insulating fluid, thereby preventing the piezoelectric vibrator from being deteriorated by the moisture infiltrating from an outside. A hydrophobic silicone oil and a fluoric inert fluid are taken as an example of the insulating fluid. In the structure, however, the infiltrating moisture is separated from the insulating fluid because it is hydrophobic. There is a possibility that the separated moisture might be collected into an interface of the piezoelectric vibrator and the fluid. In addition, a moisture concentration is increased.

In the case in which the impregnated fluid is heavier than water, moreover, the infiltrating moisture is gathered on an upper part of a liquid level which is separated from the piezoelectric vibrator. In some cases, the separated moisture directly comes in contact with the piezoelectric vibrator by a vibration. In such cases, a dielectric breakdown is caused so that a leakage current is generated.

In a fifth embodiment, a structure for eliminating the drawbacks more reliably will be described in detail.

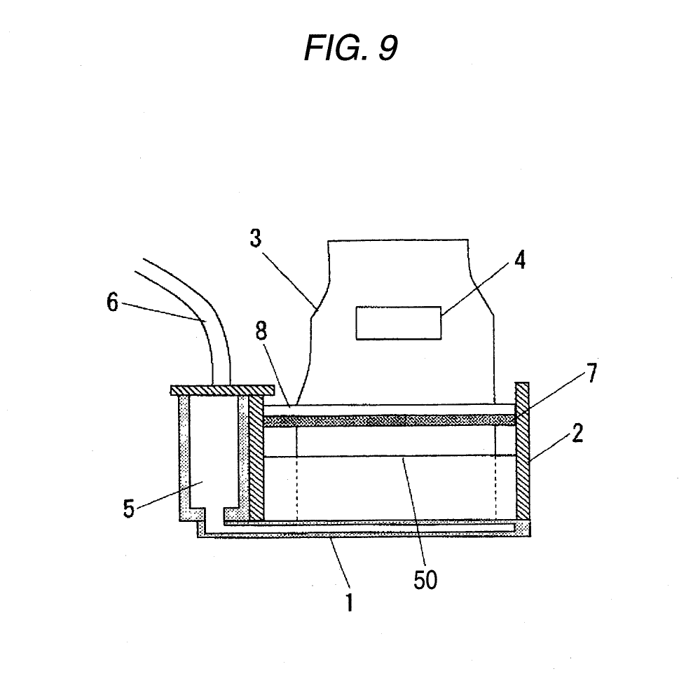

FIG. 9 is a sectional view showing an ink jet head unit according to the fifth embodiment of the invention as seen from a front side.

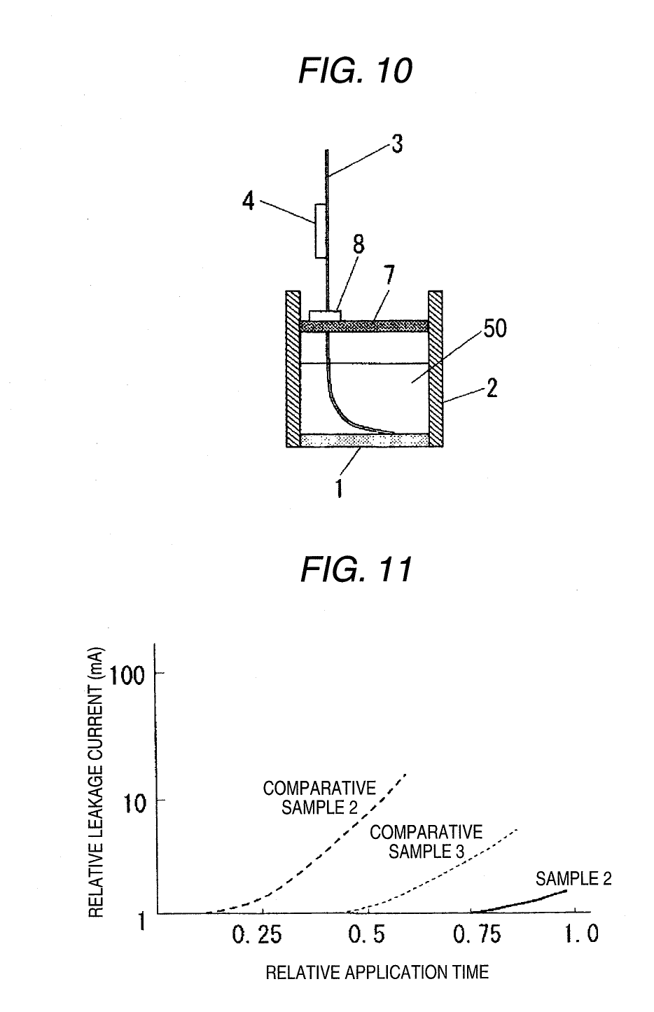

FIG. 10 is a sectional view showing the ink jet head unit according to the fifth embodiment of the invention as seen from a side.

Since a whole structure of an ink jet head board and structures of a piezoelectric actuator portion and a pressure chamber member in the ink jet head unit according to the fifth embodiment are common to those described in the first embodiment, description will be omitted.

In FIGS. 9 and 10, 50 denotes a hydrophilic fluid for adsorbing moisture in a sealed space.

As shown in FIGS. 9 and 10, the ink jet head unit according to the fifth embodiment comprises an ink jet head board l including a head body portion having a pressure chamber for discharging a supplied ink from an opening portion with a pressure change and a piezoelectric vibrator provided on one surface side of the pressure chamber in the head body portion and serving to apply a pressure to the pressure chamber, a sealing member (a sealing cap 7) for sealing a space including the piezoelectric vibrator to form a sealed space together with the ink jet head board 1, and a hydrophilic fluid 50 disposed in a contact state with the piezoelectric vibrator in the sealed space.

In order to protect, from moisture, a piezoelectric actuator according to a configuration of the piezoelectric vibrator disposed in the ink jet headboard 1, there is employed a structure in which a head base 2 and the sealing cap 7 are bonded to each other through an adhesive resin 8 and are thus closed and sealed, and the closed space is filled with the hydrophilic fluid 50. The piezoelectric vibrator is covered with the hydrophilic fluid 50.

As a method of filling the closed and sealed space with the hydrophilic fluid 50, the hydrophilic fluid 50 is filled and the sealing cap 7 is then fixed with the adhesive resin 8 and is thus closed. For example, it is also possible to form a hole for filling the hydrophilic fluid 50 on a part of the sealing cap 7, to fix the sealing cap 7 with the adhesive resin 8, to then fill the sealed inner part with the hydrophilic fluid 50 by using the hole, and to finally close the hole with an adhesive.

FIG. 9 shows the case in which a gas remains in the sealed space. It has been confirmed that the same advantages can be obtained even if the whole inner part of the sealed space is filled with the hydrophilic fluid 50.

In the ink jet head unit according to the fifth embodiment which has the structure described above, a concentration of moisture infiltrating into the sealed space can be reduced by the hydrophilic fluid 50. Therefore, it is possible to prevent a dielectric breakdown of the piezoelectric vibrator from being caused by an application of a voltage.

Even if the piezoelectric vibrator is closed and sealed, it is impossible to perfectly suppress the infiltration of the moisture from the outside air. The moisture is present to some degree in the sealed space with the passage of time. The piezoelectric vibrator to be used in the ink jet head unit causes the dielectric breakdown with a very small amount of moisture. In the ink jet head unit according to the fifth embodiment, therefore, it is possible to reduce the concentration of the infiltrating moisture so as not to cause the dielectric breakdown of the piezoelectric vibrator by filling the inner part of the sealed space with the hydrophilic fluid 50.

Moreover, the moisture infiltrating into the sealed space is not a fluid but steam or a gas. The steam infiltrates from a fine gap more easily than the moisture in a fluid state, and furthermore, an infiltrating speed is high. For this reason, the piezoelectric vibrator is greatly damaged. By filling the inner part of the sealed space with the hydrophilic fluid 50, however, it is possible to change the infiltrating steam into the fluid state. Consequently, it is also possible to reduce the damage on the piezoelectric vibrator.

In case of a hydrophobic fluid such as a silicone oil or a fluoric inert fluid according to the conventional art, furthermore, the infiltrating moisture is separated from the hydrophobic fluid and is accumulated in an interface of the piezoelectric vibrator and the hydrophobic fluid in a high moisture concentration. However, the problem can also be improved.

According to the ink jet head unit in accordance with the fifth embodiment, therefore, it is possible to reduce the influence of the moisture on the piezoelectric vibrator as compared with the conventional art by the sealing structure according to the fifth embodiment for covering the piezoelectric vibrator with the hydrophilic fluid 50. Consequently, it is possible to implement an ink jet head unit having a high reliability in which a dielectric breakdown of the piezoelectric vibrator is not caused. By loading the ink jet head unit, it is possible to implement an ink jet recording apparatus capable of maintaining printing quality which is stabilized for a long time.

As a material of the protecting film 115 described above, it is preferable to use a soft material having a low Young's modulus so as not to disturb the motion of the piezoelectric vibrator. Depending on the characteristic of the piezoelectric vibrator and the thickness of the protecting film 115, it is also possible to use a material having a high Young's modulus such as oxide or nitride. In this case, the film thickness is approximately 1 μm at most. For example, it is possible to take a material such as magnesium oxide (MgO), germaniummonoxide (GeO), alumina (Al₂O₃), nickel oxide (NiO), calcium oxide (CaO), silicon monoxide (SiO), silicon dioxide (SiO₂), aluminum nitride (AlN), boron nitride (BN) or silicon nitride (Si₃N₄).

The protecting film 115 can be fabricated by a sputtering method, an electron beam evaporation method, a resistance heating evaporation method or an ion plating method.

Moreover, an elastomer material such as rubber is suitable for a soft material, and a silicone resin, a fluororesin and butyl rubber can be taken as an example and can be cured by heat or UV irradiation. In some cases in which the elastomer materials are formed in a thickness of approximately several hundreds μm, the motion of the piezoelectric vibrator is not influenced depending on the Young's moduli of the materials. With a two-layer structure in which an elastomer material is formed on the piezoelectric vibrator and a material having a high Young's modulus such as oxide or nitride is then formed, moreover, there is no problem and the same advantages can be obtained.

In the fifth embodiment, furthermore, there is employed a structure in which the protecting film 115 covers a surface of the piezoelectric vibrator. By a synergistic effect of the hydrophilic fluid 50 and the protecting film 115, therefore, the influence of the moisture on the piezoelectric vibrator can be reduced more effectively. In the inkjet head unit having the structure according to the fifth embodiment, therefore, a current leakage is not caused by the dielectric breakdown of the piezoelectric vibrator. Consequently, it is possible to maintain excellent printing quality for a longer time.

Even if the surface of the piezoelectric vibrator is subjected to a water repellent treatment in place of the protecting film 115, moreover, the influence of the moisture on the piezoelectric vibrator can be reduced more effectively by the synergistic effect of the hydrophilic fluid 50 and the water repellent treatment. Accordingly, the current leakage is not caused by the dielectric breakdown of the piezoelectric vibrator. Consequently, the excellent printing quality can be maintained for a long time.

In this case, a solution containing water and hydrochloric acid is added to a raw solvent obtained by mixing an alkoxysilane compound forming a water repellent film principal skeleton and fluoroalkylalkoxysilane for giving a high water repellent function at an optimum ratio, for example, and agitation and polymerization are carried out to fabricate a coating solution in a sol state. The coating solution is applied to cover a head component by a spin coating method and is then burned at approximately 200□ so that a water repellent thin film can be formed.

Moreover, the water repellent treatment may be carried out over the surface of the piezoelectric vibrator by using a fluoric material. The fluoric water repellent treating material has a high performance and a water repellent effect can be maintained for a long period of time. Therefore, it is possible to prevent the dielectric breakdown of the piezoelectric vibrator from being caused by an application of a voltage for a long period of time.

In the fifth embodiment, an ink jet head unit having the sealing structure according to the invention is fabricated (which will be hereinafter referred to as a sample 2), and reliabilities of the ink jet head unit having the conventional structure and the sample 2 are compared with each other.

FIG. 11 is a characteristic chart showing reliabilities of the ink jet head unit according to the fifth embodiment of the invention and the conventional ink jet head unit.

FIG. 11 is the characteristic chart showing a relationship between a voltage application time and a leakage current.

The reliability is evaluated in an environment having a temperature of 40□ and a humidity of 60%, and a voltage of 30V is continuously applied to measure a current which flows.

In the sample 2, denatured polyethylene oxide resin sealing is used for the head base 2, an aluminum (Al) metal is used for the sealing cap 7, and a fluororesin of a heat curing type is used for the adhesive resin 8 for fixing them. Moreover, glycerin is used for the hydrophilic fluid 50 to be filled in the sealed space. As a method of filling the glycerin, the sealing cap 7 having a hole formed thereon is fixed to the head base 2 and the glycerin is then filled in the sealed space through the hole, and the hole is finally closed with an ultraviolet (UV) resin.

For the conventional ink jet head unit fabricated for the comparison, there are prepared a comparative sample 2 having such a structure that a sealed space is filled with nothing and a comparative sample 3 having such a structure that a sealed space is filled with a silicone oil in a dimethyl polysiloxane structure. The other components and fabricating methods in the comparative samples are set to be the same as those of the sample 2.

In FIG. 11, from a comparison among reliability evaluation results of the sample 2, the comparative sample 2 and the comparative sample 3, it is apparent that an increase in a leakage current is not observed for a long period of time in the sample 2. On the other hand, the reliability of the comparative sample 3 filled with the silicone oil is improved more greatly than the comparative sample 2 filled with nothing and is much poorer than that of the sample 2. In other words, it is apparent that the sample 2 fabricated with the structure according to the fifth embodiment can eliminate the influence of moisture on the piezoelectric vibrator and can maintain excellent printing quality for a long period of time also in an environment having a high temperature and a high humidity.

Referring to the sample 2, only the glycerin to be an alcoholic fluid has been described as the hydrophilic fluid 50 to be filled in the sealed space. However, an equivalent performance to the glycerin can be obtained by other alcoholic fluids, for example, ethanol, methanol and isopropyl alcohol. For the hydrophilic fluid 50 to be filled in the sealed space at this time, moreover, a solvent such as acetone or dichlorobenzene may be used as the hydrophilic fluid 50 other than the alcoholic fluid.

In the fifth embodiment, it is sufficient that a characteristic demanded for a fluid to be filled in the sealed space is a hydrophilic fluid. In case of a polar solvent having a polar group, it is possible to exhibit the advantages of the invention described above.

In the foregoing, there has been evaluated the reliability in a continuous electrification in the environment having a temperature of 40□ and a humidity of 60%. Also in a preservation test in which a leakage current is evaluated after a preservation for a long time in a poorer environment, it has been confirmed that the ink jet head unit according to the fifth embodiment can obtain a higher reliability as compared with the conventional structure.

More specifically, in case of a preservation in an environment having a temperature of 60□ and a humidity of 90%, a current leakage is generated after approximately 10 hours in the conventional ink jet head unit filled with nothing (the comparative sample 2) and after approximately 200 hours in the conventional ink jet head unit filled with the silicone oil (the comparative sample 3). On the other hand, in the ink jet head unit fabricated with the structure according to the fifth embodiment and filled with the glycerin (the sample 2), an increase in the leakage current is not observed even if the evaluation is carried out after the preservation for 500 hours.

As a variant of the fifth embodiment, next, description will be given to a structure in which powder of a drying agent is added to the hydrophilic fluid 50.

In the variant of the fifth embodiment, there is fabricated an ink jet head unit in which powder of a molecular sieve is added to glycerin to be the hydrophilic fluid 50 and a sealed space including a piezoelectric vibrator is filled therewith (which will be hereinafter referred to as a sample 3). The other components and fabricating methods are set to be the same as those of the sample 2. A reliability of the ink jet head unit thus constituted is evaluated. In the ink jet head unit according to the sample 3, it can be confirmed that an equivalent reliability or more can be obtained as compared with the sample 2, there is no problem even if powder of a drying agent is added to the hydrophilic fluid 50 and the advantages of the invention can be produced.

Although the type of the drying agent to be added to the hydrophilic fluid 50 is not particularly restricted, it is preferable that a state should not be changed due to an adsorption of moisture. In the sense, a drying agent for physically adsorbing the moisture is preferable to a drying agent for adsorbing the moisture by a chemical function causing a deliquescent property and a volume expansion due to the adsorption of the moisture. The molecular sieve is a typical drying agent for absorbing the moisture by a physical function and is also suitable for drying a fluid in addition to a gas.

Moreover, a smaller size of the drying agent to be added to the hydrophilic fluid 50 is preferable. The reason is that the piezoelectric vibrator and the drying agent might directly come in contact with each other because the drying agent is directly added to the hydrophilic fluid 50 to be filled in the sealed space. When the size of the drying agent to be added to the hydrophilic fluid 50 is increased, a displacement of the piezoelectric vibrator is disturbed so that a discharge of an ink is badly influenced. The size of the piezoelectric vibrator is varied depending on a piezoelectric performance or a recording density. Since the size is approximately several tens μm to several hundreds μm, however, it has been confirmed that a discharging performance is not influenced if the drying agent has a size which is equal to or smaller than approximately several tens μm to several hundreds μm.

For the drying agent, moreover, it is also possible to use the drying agent 9 obtained by combining the drying agent having such a characteristic as to physically adsorb the moisture and the drying agent having such a characteristic as to chemically adsorb the moisture which have been described in detail in the first embodiment. In this case, for example, it is desirable that the drying agent 9 should be bonded to the sealing cap 7 and a height for injecting the hydrophilic fluid 50 should be set so as not to come in contact with the drying agent 9 as shown in FIG. 4. Moreover, it is also possible to separately provide a film constituted by a polymeric material between the hydrophilic liquid 50 and the drying agent 9, for example, and to partition and dispose the hydrophilic fluid 50 and the drying agent 9 on a spatial basis.

### Sixth Embodiment

FIG. 12 is a sectional view showing an ink jet head unit according to a sixth embodiment of the invention as seen from a side.

In the sixth embodiment, differently from the case shown in the fifth embodiment, a flexible printed board 3 is electrically connected to an ink jet head board 1 having a piezoelectric actuator formed thereon at an outside where the ink jet head board 1 is sealed and closed. The electrical connection is carried out by thermocompression bonding using an anisotropic conductive film, for example.

The ink jet head unit according to the sixth embodiment has the same structure as that in the fifth embodiment except that the flexible printed board 3 is perfectly separated from a closed space formed by an internal sealing cap 51, and a hydrophilic fluid 50 covers a piezoelectric vibrator.

Also in the ink jet head unit according to the sixth embodiment which has the structure, it is possible to obtain the same advantages as those in the ink jet head unit according to the fifth embodiment. The ink jet head unit subjected to the sealing has a high reliability. More specifically, also in the ink jet head unit according to the sixth embodiment, it is possible to reduce an influence of moisture on the piezoelectric vibrator more greatly than that in the conventional art. Therefore, it is possible to implement an ink jet head unit having a high reliability in which a dielectric breakdown of the piezoelectric vibrator is not caused. By loading the ink jet head unit, it is possible to implement an ink jet recording apparatus capable of maintaining stable printing quality for a long time.

In the ink jet head unit according to the sixth embodiment, moreover, an infiltration of the moisture from the flexible printed board 3 and an interface including the flexible printed board 3 is lessened as compared with the structure according to the fifth embodiment. Therefore, a concentration of the moisture contained in the hydrophilic fluid 50 is maintained to be low. Accordingly, the ink jet head unit according to the embodiment has an advantage that a long-term reliability can be further enhanced as compared with the sealing structure described in the first embodiment.

### Seventh Embodiment

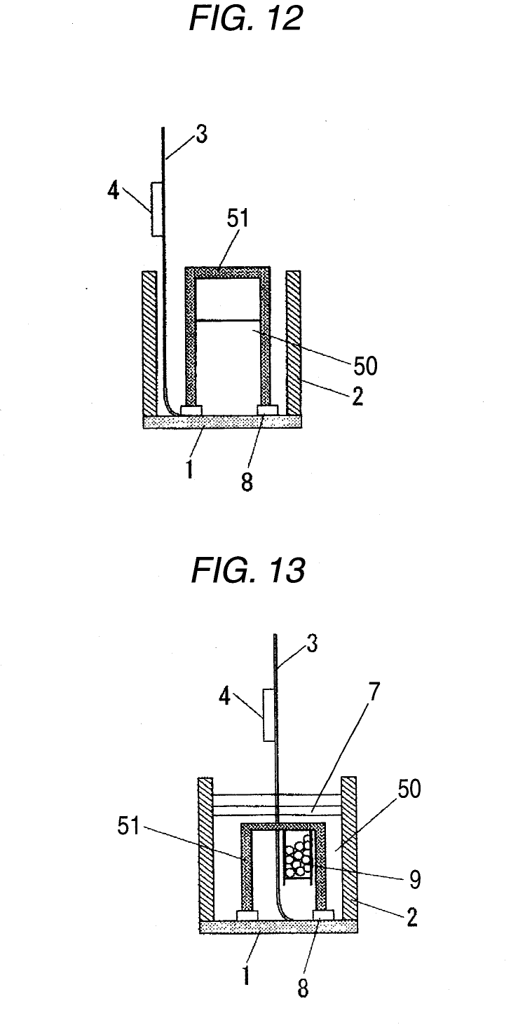

FIG. 13 is a sectional view showing an ink jet head unit according to a seventh embodiment of the invention as seen from a side.

In the seventh embodiment, a double sealing structure is employed differently from the case according to the fifth embodiment. A piezoelectric vibrator is sealed with an internal sealing cap 51 and the sealing structure is provided on an outside thereof. There is employed a structure in which a hydrophilic fluid 50 is not filled in an interface including the piezoelectric vibrator but a sealed space between the internal sealing cap 51 and a sealing structure provided on an outside thereof. Moreover, a drying agent 9 is filled in a space which seals the piezoelectric vibrator.

Thus, the ink jet head unit according to the fifth embodiment comprises an ink jet head board 1 including a head body portion having a pressure chamber for discharging a supplied ink from an opening portion with a pressure change and a piezoelectric vibrator provided on one surface side of the pressure chamber in the head body portion and serving to apply a pressure to the pressure chamber, a first sealing member (a sealing cap 7) for sealing a space including the piezoelectric vibrator to form a first sealed space together with the ink jet head board 1, a second sealing member (an internal sealing cap 51) for sealing a space including the piezoelectric vibrator to form a second sealed space in the first sealed space (an internal sealing cap 51), and the hydrophilic fluid 50 disposed in a space between the first sealed space and the second sealed space. The drying agent 9 is filled in the second sealed space.

It is possible to use materials constituting the hydrophilic fluid 50 to be filled, the drying agent 9, an adhesive for carrying out the sealing and the internal sealing cap 51 which are the same as those described in the first embodiment.

In particular, it is desirable to use the drying agent 9 obtained by combining the drying agent having such a characteristic as to physically adsorb the moisture and the drying agent having such a characteristic as to chemically adsorb the moisture which has described in the first embodiment. Consequently, it is possible to maintain a drying performance having a very high level for a long period of time.

According to the structure of the ink jet head unit in accordance with the seventh embodiment, the moisture infiltrating from the outside is first diluted with the hydrophilic fluid 50 and is brought into a fluid state so that it is hard to reach a space including the piezoelectric vibrator. Even if the space including the piezoelectric vibrator (a sealed space formed by the internal sealing cap 51) is reached, the moisture is removed with the drying agent 9. Therefore, a dielectric breakdown of the piezoelectric vibrator is not caused and a leakage current is not generated.

The internal sealing cap 51 is surrounded by the hydrophilic fluid 50. Therefore, it is hard to cause the infiltration of the moisture in a gaseous state. Therefore, a component of the internal sealing cap 51 does not need to be restricted to a component having a low moisture permeability, for example, a metal.

Also in the ink jet head unit according to the seventh embodiment which has the structure, it is possible to obtain the same advantages as those in the ink jet head unit according to the fifth embodiment. The ink jet head unit subjected to the sealing has a high reliability. More specifically, also in the ink jet head unit according to the seventh embodiment, it is possible to reduce an influence of the moisture on the piezoelectric vibrator more greatly than that in the conventional art. Therefore, it is possible to implement an ink jet head unit having a high reliability in which a dielectric breakdown of the piezoelectric vibrator is not caused. By loading the ink jet head unit, it is possible to implement an ink jet recording apparatus capable of maintaining stable printing quality for a long time.

In the seventh embodiment, moreover, the double sealing structure is employed as described above. Therefore, the moisture infiltrating from the outside does not directly enter the sealed space including the piezoelectric vibrator as steam in a gaseous state but in a state of a fluid obtained by a conversion from a gas to a fluid and a dissolution into a hydrophilic fluid. Therefore, it is possible to reduce an amount of the infiltration of the moisture into the sealed space including the piezoelectric vibrator and to effectively prevent the dielectric breakdown of the piezoelectric vibrator from being caused by an application of a voltage for a long time.

As described above in detail, the fifth to seventh embodiments include the following invention.

An ink jet head unit according to the embodiments of the invention comprises an ink jet head board including a head body portion having a pressure chamber for discharging a supplied ink from an opening portion with a pressure change, and a piezoelectric vibrator provided on one surface side of the pressure chamber in the head body portion and serving to apply a pressure to the pressure chamber, a sealing member for sealing a space including the piezoelectric vibrator to form a sealed space together with the ink jet head board, and a hydrophilic fluid disposed in a contact state with the piezoelectric vibrator in the sealed space. Consequently, there is obtained a function of reducing a concentration of the moisture infiltrating into the sealed space with the hydrophilic fluid and preventing the dielectric breakdown of the piezoelectric vibrator from being caused by an application of a voltage.

By disposing the hydrophilic fluid, moreover, it is possible to change steam infiltrating into the sealed space surrounding the piezoelectric vibrator into a fluid state. Therefore, it is also possible to reduce a damage on the piezoelectric vibrator. In case of a hydrophobic fluid such as a silicone oil or a fluoric inert fluid according to the conventional art, furthermore, the infiltrating moisture is separated from the hydrophobic fluid and is thus accumulated in a state having a high moisture concentration in an interface of the piezoelectric vibrator and the hydrophobic fluid. However, the problem can also be improved. Consequently, it is possible to suppress the influence of the moisture on the piezoelectric vibrator for a long time. Thus, it is possible to obtain an ink jet head unit which prevents the dielectric breakdown of the piezoelectric vibrator from being caused by the application of the voltage and has a high reliability.

In the embodiments according to the invention, moreover, the protecting film is formed on the surface of the piezoelectric vibrator and the concentration of the moisture infiltrating into the sealed space can be reduced with the hydrophilic fluid, and furthermore, the influence of the moisture can be suppressed by the protecting film. Therefore, it is possible to obtain a function of preventing the dielectric breakdown of the piezoelectric vibrator from being caused by the application of the voltage for a long period of time.

In addition, according to the embodiments of the invention, the surface of the piezoelectric vibrator is subjected to the water repellent treatment and the concentration of the moisture infiltrating into the sealed space is reduced with the hydrophilic fluid, and furthermore, the water of the fluid is repelled by the water repellent treatment so that the influence of the moisture is suppressed. Therefore, it is possible to obtain a function of preventing the dielectric breakdown of the piezoelectric vibrator from being caused by the application of the voltage for a long period of time.

In the embodiments according to the invention, moreover, the water repellent treatment is carried out with a fluoric material. The fluoric water repellent treating material has a high performance and the influence of the moisture through the water repellent treatment can be suppressed for a long period of time. Therefore, it is possible to obtain a function of preventing the dielectric breakdown of the piezoelectric vibrator from being caused by the application of the voltage for a long period of time.

In addition, according to the embodiments of the invention, the hydrophilic fluid is set to be an alcoholic fluid, and an alcoholic solution has a high solubility of the moisture. Even if a large amount of moisture infiltrates, therefore, it is possible to reduce an amount of the moisture contained in the fluid for a long period of time. Thus, it is possible to obtain a function of preventing the dielectric breakdown of the piezoelectric vibrator from being caused by the application of the voltage for a long period of time.

In the embodiments according to the invention, moreover, the hydrophilic fluid contains at least one of water and alcoholic fluids and the surface of the piezoelectric vibrator is subjected to the water repellent treatment. Therefore, the water of the fluid is repelled so that the influence of the moisture is suppressed. Furthermore, the alcoholic solution has a high solubility of the moisture. Even if a large amount of moisture infiltrates, therefore, the amount of the moisture contained in the fluid is reduced for a long period of time. Consequently, it is possible to obtain a function of preventing the dielectric breakdown of the piezoelectric vibrator from being caused by the application of the voltage for a long period of time.

In addition, according to the embodiments of the invention, the powdered drying agent is dispersed in the hydrophilic fluid and the moisture contained in the hydrophilic fluid in an early stage is removed with the powdered drying agent, and furthermore, the moisture infiltrating later is removed with the powdered drying agent. Therefore, the amount of the moisture contained in the fluid can be reduced for a long period of time. Thus, it is possible to obtain a function of preventing the dielectric breakdown of the piezoelectric vibrator from being caused by the application of the voltage for a long period of time.

In the embodiments according to the invention, moreover, the powdered drying agent is set to be the molecular sieve. Since the molecular sieve has a small change in a state due to the adsorption of the moisture, it is suitable for the drying agent to adsorb the moisture in the fluid and can efficiently remove the moisture contained in the hydrophilic fluid. Consequently, it is possible to obtain a function of preventing the dielectric breakdown of the piezoelectric vibrator from being caused by the application of the voltage for a long period of time.

In addition, in the embodiments according to the invention, there are provided an ink jet head board including a head body portion having a pressure chamber for discharging a supplied ink from an opening portion with a pressure change, and a piezoelectric vibrator provided on one surface side of the pressure chamber in the head body portion and serving to apply a pressure to the pressure chamber, a first sealing member for sealing a space including the piezoelectric vibrator to form a first sealed space together with the ink jet head board, a second sealing member for sealing the space including the piezoelectric vibrator to form a second sealed space in the first sealed space, and a hydrophilic fluid disposed in a space between the first sealed space and the second sealed space. The moisture infiltrating from the outside does not directly infiltrate into the second sealed space including the piezoelectric vibrator as steam in a gaseous state but in a fluid state obtained by a conversion from a gas to a fluid and a dissolution into a hydrophilic fluid. Therefore, it is possible to reduce an amount of the infiltration of the moisture into the second sealed space. Consequently, it is possible to obtain a function of preventing the dielectric breakdown of the piezoelectric vibrator from being caused by the application of the voltage for a long period of time.

In the embodiments according to the invention, moreover, the hydrophilic fluid contains at least one of water and alcoholic fluids and the moisture infiltrating from the outside does not directly infiltrate into the second sealed space including the piezoelectric vibrator as steam in a gaseous state but in a fluid state obtained by a conversion from a gas to a fluid and a dissolution into a hydrophilic fluid. Therefore, it is possible to reduce an amount of the infiltration of the moisture into the second sealed space. In addition, the alcoholic solution has a high solubility of the moisture. Consequently, it is possible to obtain a function of preventing the dielectric breakdown of the piezoelectric vibrator from being caused by the application of the voltage for a long period of time.

In the embodiments according to the invention, furthermore, the drying agent is provided in the second sealed space. Even if the moisture infiltrates into the second sealed space including the piezoelectric vibrator, the moisture is removed with the drying agent. Therefore, it is possible to obtain a function of preventing the dielectric breakdown of the piezoelectric vibrator from being caused by the application of the voltage for a long period of time.

It is desirable that the drying agent should be obtained by combining the drying agent having such a characteristic as to physically adsorb the moisture and the drying agent having such a characteristic as to chemically adsorb the moisture.

In addition, the embodiments according to the invention are characterized in that the ink jet head unit is loaded, and have a function of stabilizing the printing quality for a long period of time.

As described above, the ink jet head unit according to the invention is useful for the field of an ink jet recording apparatus for discharging an ink to form an image by utilizing a displacement of a piezoelectric vibrator.

1. An ink jet head unit comprising:
a pressure chamber for discharging an ink with a pressure change;
a piezoelectric vibrator provided in the pressure chamber and serving to apply a pressure to the pressure chamber;
a sealing member for sealing a space including at least the piezoelectric vibrator; and
plural kinds of drying agents disposed in a sealed space formed by the sealing member and having moisture absorbing characteristics which are different from each other.

2. The ink jet head unit according to claim 1, wherein the drying agent is constituted by mixing:
a first drying agent having a moisture absorbing characteristic to physically adsorb moisture; and
a second drying agent having a moisture absorbing characteristic to chemically adsorb moisture.

3. The ink jet head unit according to claim 2, wherein the first drying agent is set to be a molecular sieve.

4. The ink jet head unit according to claim 2, wherein the second drying agent is calcium oxide, calcium chloride or magnesium chloride.

5. The ink jet head unit according to claim 1, wherein the drying agent is disposed in the sealed space in a state to be filled in a bag.

6. The ink jet head unit according to claim 5, wherein the bag in which the drying agent is filled is disposed separately from the ink jet head board.

7. The ink jet head unit according to claim 5, wherein the bag in which the drying agent is filled is supported in a hollow portion of the sealed space.

8. The ink jet head unit according to claim 5, wherein the bag filled with the drying agent is constituted by a polymer film.

9. The ink jet head unit according to claim 1, wherein at least a part of a member constituting the sealed space is constituted by a resin.

10. The ink jet head unit according to claim 1, wherein a hydrophilic fluid is further put in the sealed space.

11. An ink jet head unit comprising:
an ink jet head board including a head body portion having a pressure chamber for discharging a supplied ink from an opening portion with a pressure change, and a piezoelectric vibrator provided on one surface side of the pressure chamber in the head body portion and serving to apply a pressure to the pressure chamber;
a first sealing member for sealing a space including the piezoelectric vibrator to form a first sealed space together with the ink jet head board;
a second sealing member for sealing the space including the piezoelectric vibrator to form a second sealed space in the first sealed space;
plural kinds of drying agents disposed in the second sealed space and having moisture absorbing characteristics which are different from each other; and
a hydrophilic fluid disposed in a space provided between the first sealed space and the second sealed space.

12. An ink jet recording apparatus loading the ink jet head unit according to claim 1.

13. A method of manufacturing an ink jet head unit comprising:
a head body portion forming step of forming a head body portion including a pressure chamber for discharging a supplied ink from an opening portion with a pressure change;
an ink jet head board forming step of forming a piezoelectric vibrator for applying a pressure to the pressure chamber to form an ink jet head board on one surface side of the pressure chamber in the head body portion; and
a sealing step of sealing a space including a drying agent constituted by at least two kinds of different components and the piezoelectric vibrator to form a sealed space together with the ink jet head board,
wherein the drying agent is disposed to carry out sealing in a drying gas atmosphere at the sealing step.

14. The method of manufacturing an ink jet head unit according to claim 13, wherein the drying gas is set to be a gas having a greater molecular weight than water.

15. An ink jet recording apparatus loading the ink jet head unit according to claim 11.
